(19) United States
(12) Patent Application Publication
(10) Pub. No.: US 2009/0325531 A1
(43) Pub. Date: Dec. 31, 2009

(54) Method and circuit arrangement for prevention of interference in an intermediate frequency signal and am receiver comprising such a method of circuit arrangement

(75) Inventor: Cord-Heinrich Kohsiek, Ellerau (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., EINDHOVEN (NL)

(21) Appl. No.: 11/629,118

(22) PCT Filed: Jun. 2, 2005
(86) PCT No.: PCT/IB05/51790

§ 371 Date: Mar. 23, 2009

(51) Int. Cl. H04B 1/10

(52) U.S. Cl. 455/307

(57) ABSTRACT

In a method and a circuit arrangement for preventing interference pulses in the intermediate frequency signal in an AM receiver comprising a mixer, in which a high frequency signal fed to the mixer is blanked out when interference occurs, it is provided that, while the high frequency signal is blanked out, a filter provided for the intermediate frequency signal is undamped.

### FIELD OF THE INVENTION

The invention relates to a method and a circuit arrangement for preventing interference pulses in the intermediate frequency signal in an AM receiver comprising a mixer, in which a high frequency signal fed to the mixer is blanked out when interference occurs. The invention moreover relates to an AM receiver comprising such a method and such a circuit arrangement.

### BACKGROUND OF THE INVENTION

When the high frequency signal is blanked out as claimed in the preamble, an interference pulse occurs in the intermediate frequency signal since the amplitude thereof decreases on account of the damping of the filter during the interruption brought about by the blanking-out of the high frequency signal and thus interference also occurs in the subsequently demodulated signal.

### OBJECT AND SUMMARY OF THE INVENTION

In the method according to the invention, such interference can be prevented in that, while the high frequency signal is blanked out, a filter provided for the intermediate frequency signal is undamped.

Since an interference pulse is extended as it is passed through a number of intermediate frequency filters, in the method according to the invention it is preferably provided that the filter lying in the output circuit of the mixer is undamped.

One particularly simple embodiment of the method according to the invention consists in that the undamping is brought about by switching on a negative resistance.

In the circuit arrangement according to the invention, interference pulses are prevented in that the damping of a filter provided for the intermediate frequency signal can be reduced. In this case, a negative resistance which can be switched on is preferably provided for reducing the damping. In order to keep the blanking-out time as short as possible and thus any remaining residual interference as low as possible, the circuit arrangement according to the invention may be configured in such a way that the filter lying in the output circuit of the mixer is provided with a device for undamping purposes.

One simple embodiment is possible in that a negative resistance can be switched on for undamping purposes.

One particularly simple embodiment of the negative resistance is possible in that the negative resistance is formed by two amplifiers, of which the inputs are connected via a respective voltage divider to in each case one terminal of the filter and the outputs are connected to the respective other terminal of the filter. In this case, it is preferably provided that the amplifiers are formed by in each case at least one transistor, wherein a switch is provided in a common supply line for supplying the operating voltage to the emitters of the transistors, and that impedance converters are connected upstream of the transistors.

This embodiment of the negative resistance takes account of the generally usually symmetrical design of the output circuit of the mixer. Furthermore, a negative resistance which is constant over a large amplitude range is thereby achieved.

### BRIEF DESCRIPTION OF THE DRAWINGS

The invention will be further described with reference to examples of embodiments shown in the drawings to which, however, the invention is not restricted.

FIG. 1 shows a schematic diagram of the example of embodiment.

FIG. 2 shows a more detailed diagram.

### DESCRIPTION OF EMBODIMENTS

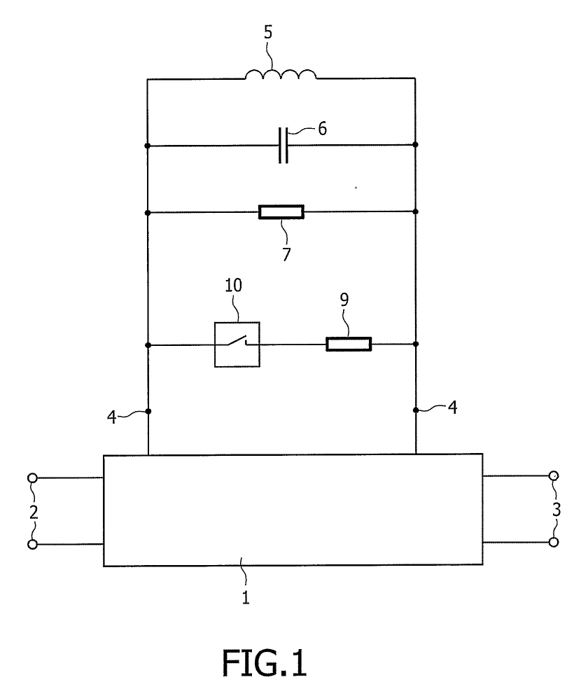

FIG. 1 shows a mixer 1 which is known per se, to which the high frequency signal can be fed via an input 2 and to which an oscillator signal can be fed via a further input 3. As in known AM receivers, as an intermediate frequency filter a resonant circuit which consists of a coil 5 and a capacitor 6 is connected to an output 4, which like the inputs 2, 3 is designed to be symmetrical. In the schematic diagram of FIG. 1, a resistance 7 is shown by way of example for various damping components of the resonant circuit 5, 6.

Without further measures, the resonant circuit 5, 6, 7 which forms the intermediate frequency filter carries out damped oscillation when the high frequency signal fed in at 2 is blanked out. The original amplitude is achieved again only once the high frequency signal has been introduced. This interference manifests itself as an interference pulse in the demodulated signal. In order to prevent this, in the circuit arrangement shown in FIG. 1, a negative resistance 9 is connected in series with a switch 10 in parallel with the resonant circuit 5, 6, 7. The negative resistance 9 is designed such that the damping resistance 7 is practically compensated. When the negative resistance 9 is switched on, a high-quality resonant circuit is thus achieved, as a result of which the intermediate frequency amplitude does not decrease even during the blanking-out of the high frequency signal.

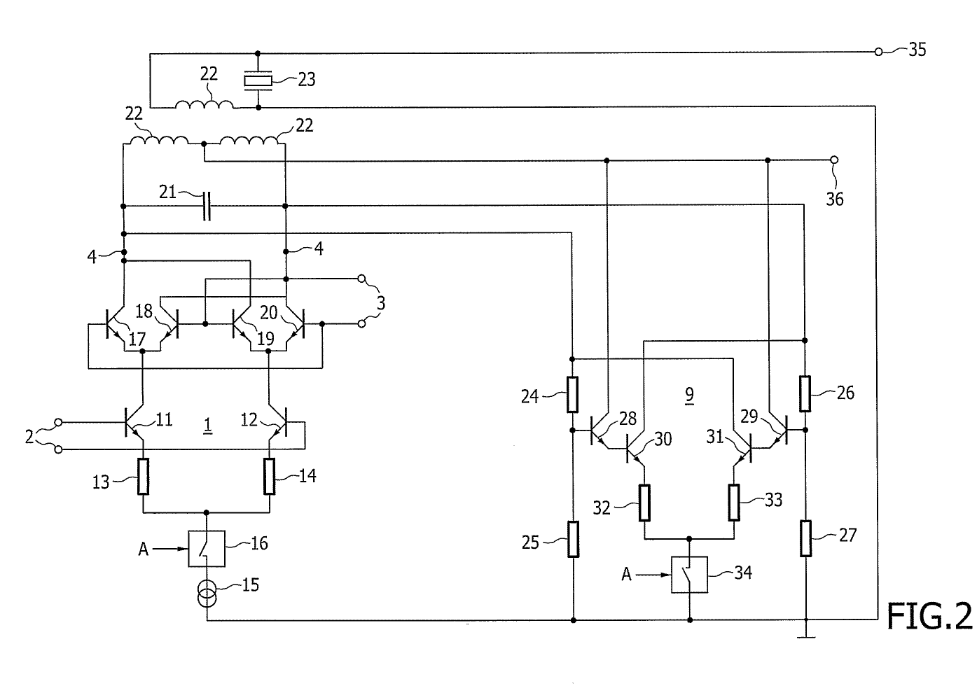

The circuit arrangement shown in FIG. 2 comprises a mixer 1 which in a manner known per se is designed to be symmetrical in the form of differential amplifiers. Current is supplied by a constant current source 15 to the emitters of two first transistors 11, 12 via a respective resistance 13, 14, wherein a switch 16 controlled by a blanking pulse A is provided for blanking out the high frequency signal fed in at 2. Connected to the collectors of the transistors 11, 12 are emitters of in each case a pair of second transistors 17, 18; 19, 20, wherein the base terminals of these transistors form the input 3 for the oscillator frequency. The collectors of the transistors 17, 19 and 18, 20 in each case form a pole of the output 4 of the mixer.

In this example of embodiment, the intermediate frequency filter is formed by a capacitor 21, a transformer 22 and a ceramic filter 23. The actual filter function is performed by the ceramic filter 23, whereas the resonant circuit formed by inductances of the transformer 22 and capacitor 21 suppresses secondary pass-bands lying next to the main pass-band of the ceramic filter 23. The resonant circuit is damped by various losses within the transformer and the coils thereof and also by the loading by the ceramic filter 23.

In order to compensate this damping, a negative resistance 9 formed by two amplifiers is provided, wherein the voltage at each terminal of the resonant circuit is fed via a respective voltage divider 24, 25; 26, 27 to the base of a respective emitter follower 28, 29 which is cascaded with a respective transistor 30, 31. The collectors of the transistors 30, 31 are then connected to the resonant circuit. The emitter current of the transistors 30, 31 is fed via a respective resistance 32, 33 and a common switch 34 which is controlled by the blanking pulse A. If said switch is closed, the negative resistance is active and the damping of the resonant circuit 21, 22 is reduced. The intermediate frequency signal can be taken from a terminal 35 for further processing. A positive operating voltage is fed in at 36.

1. A method of preventing interference pulses in the intermediate frequency signal in an AM receiver comprising a mixer, in which a high frequency signal fed to the mixer is blanked out when interference occurs, characterized in that, while the high frequency signal is blanked out, a filter provided for the intermediate frequency signal is undamped.

2. A method as claimed in claim 1, characterized in that the filter lying in the output circuit of the mixer is undamped.

3. A method as claimed in claim 1, characterized in that the undamping is brought about by switching on a negative resistance.

4. A circuit arrangement for preventing interference pulses in the intermediate frequency signal in an AM receiver comprising a mixer, in which a high frequency signal fed to the mixer is blanked out when interference occurs, characterized in that the damping of a filter provided for the intermediate frequency signal can be reduced.

5. A circuit arrangement as claimed in claim 4, characterized in that a negative resistance which can be switched on is provided for reducing the damping.

6. A circuit arrangement as claimed in claim 4, characterized in that the filter lying in the output circuit of the mixer is provided with a device for undamping purposes.

7. A circuit arrangement as claimed in claim 4, characterized in that a negative resistance can be switched on for undamping purposes.

8. A circuit arrangement as claimed in claim 7, characterized in that the negative resistance is formed by two amplifiers, of which the inputs are connected via in a respective voltage divider to in each case one terminal of the filter and the outputs are connected to the respective other terminal of the filter.

9. A circuit arrangement as claimed in claim 8, characterized in that the amplifiers are formed by in each case at least one transistor wherein a switch is provided in a common supply line for supplying the operating voltage to the emitters of the transistors.

10. A circuit arrangement as claimed in claim 9, characterized in that impedance converters are connected upstream of the transistors.

11. An AM receiver, characterized by a use of the method as claimed in claim 1.

12. An AM receiver, characterized by a circuit arrangement as claimed in claim 4.
